(19) United States
(12) Patent Application Publication
(10) Pub. No.: US 2002/0046291 A1
(43) Pub. Date: Apr. 18, 2002

(54) Network unit with address cache for frequently occurring network conversations

(76) Inventors: Sorcha O'Callaghan, Lucan (IE); Jerome Nolan, Dublin (IE); Paul O'Keeffe, Dublin (IE); David Nolan, Celebridge (IE); Kevin Jennings, Dublin (IE)

Correspondence Address: NIXON & VANDERHYE P.C., 1100 North Glebe Rd., 8th Floor, Arlington, VA, 22201-4714, US

(21) Appl. No.: 09/725,476

(22) Filed: Nov. 30, 2000

(30) Foreign Application Priority Data
Oct. 18, 2000 (GB) 0025507.5

(51) Int. Cl. G06F 15/16

(52) U.S. Cl. 709/238; 709/245

(57) ABSTRACT

A network unit includes a cache memory for storing address pairs of frequently-occurring packet conversations through the unit On a look-up request, a cache controller checks whether an address pair is held in the cache before allowing a normal look-up in a layer database. The controller has recourse to RMON statistics to update the cache by inserting address pairs of more frequent conversations in place of those for less frequent conversations

### FIELD OF THE INVENTION

This invention relates to network units, that is to say multi-port units which can receive and transmit addressed data packets, such as, for example, Ethernet data packets and which need to perform address look-ups so as to relate address data, which maybe for example media access control address data or network address data or both in order to determine by means of a database relating address data to forwarding data (such as a numerical identification of a respective port or ports) which port or ports are required to send a data packet previously received by the unit. Examples of such network units are “switches”, “bridges” and “routers”. The invention more particularly relates to making a look-up process more efficient, at least in respect of addresses which appear in more frequently occurring conversations (i.e message traffic between specific representative by sources and destinations).

### BACKGROUND TO THE INVENTION

Various architectures and associated software are available for network units which are required to perform address look-ups to determine the physical destination or destinations of a packet received by a network unit of the kind to which the invention relates. A common feature of such units is a look-up table or “forwarding database” which, despite having a variety of forms and different manners of organization dependant on circumstances, in essence relates address data in a packet to forwarding data Forwarding databases are generally more complicated than the simple description indicates For example, they may cope with different layer addresses, have a variety of means of restricting unnecessary lookups, and employ “aging” to remove entries which have not been used for a particular time Furthermore, there is a variety of ways of organizing the look-ups in such a database. Owing to the considerable lengths of addresses and the high cost both financially and in temporal terms, of database searching, various schemes have been employed to reduce the memory space required and to accelerate the search process. One method of reducing the space required is to employ “hashing” of address data The search process may be organised on a binary tree basis but other forms of searching, such as “trie” searching, are now commonplace.

More complex databases may require more than the destination address of a packet for a successful look-up For example when the network unit is used in conjunction with a ‘farm’ of servers and all the servers in the farm have the same ‘virtual’ IP (internet protocol) address, the unit, in this example a router, may store traffic among the servers according to the IP source addresses of the traffic A look-up table for this purpose can be based on a trie search using a key identifying both the network destination address (i e. the servers' virtual IP address) and the IP source address, and if appropriate the identification of the virtual LAN of the source.

Such a key may be used to search a trie data structure until a leaf node is found, i e the lookup is performed by traversing the trie structure until an associated data block containing the ‘forwarding data’ is reached or the search terminates without success. Each stage in the trie uses a few more bits from the key This means that many addresses with a common prefix can refer to the same target address.

By way of further example, load balancing is a method of sharing the load between a multiplicity of servers for higher performance and for the protection of redundancy. All the servers in a server “farm” may have the same virtual internet protocol address. The router, such as the network unit 10 shown in FIG. 1, shares traffic destined for this virtual internet protocol address between the servers based on some selective algorithm One typical algorithm employs the internet protocol source address of a packet to determine which server will be selected for handling such a packet

Currently therefore in server load balancing (and also IP multicasting) the entire internet protocol destination address and internet protocol source address need to be stored in a trie look-up table This means that the search of a very long key may be required. Very typically, in a trie search the key is read in slices, and typically ten “slices” are required. This consumes substantial time and it is desirable to improve the performance of the switch by rendering more common reads are necessary.

It is known, for a variety of purposes, to provide a “cache” memory, for example constituted by a content addressable memory (CAM) Such a memory can be accessed by direct application of address data, for example as described in European patent application EP0594196-A1, wherein the content addressable memory is employed in conjunction with hashing of address data to provide a search key and particularly to deal with cases where more than a particular number of addresses would hash to the same key.

Content addressable memories, for example as described in U.S. Pat. No. 4,587,610, require only one read operation to compare all stored addresses with an incoming address However, this speed of operation is obtained at the cost of great complexity and cost The present invention will employ a content addressable memory only for a small number of address pairs.

It is known from Wakeman et al, U.S. Pat. No. 5,740,175 issued Apr. 14, 1998, to provide a network switch which includes a RAM forwarding database containing the address to port mappings for all the workstations or other devices connected to the switch's plurality of ports and at least one CAM-cache connected to a respective switch port so that when it is desired for the switch to forward a packet, the destination address is extracted and if the correct mapping is contained in the CAM-cache the packet is immediately forwarded to the destination port without accessing the much larger and slower forwarding database Wakeman et al provide for updating of the CAM-cache when it is full by inserting a new mapping for either the least recently used mapping or the least frequently used mapping in the database.

A known technique in association with network units is known as “RMON” (remote monitoring). This in essence comprises remotely controlled “snooping” on packets which pass through the switch in order to obtain information from the header portions of the packets. Remote monitoring is employed for a variety of purposes, particularly the analysis of traffic flows in the system to which the network unit is connected It is described in a variety of publications, such as for example in GB-2317542, GB-2316589, 2338147 and so on A known feature of remote monitoring is the identification of each “conversation” (identified by a pair of addresses) which is handled by the unit at any particular time.

### SUMMARY OF THE INVENTION

The present invention has the object of avoiding or at least reducing the number of look-ups in a forwarding database that may be necessary by maintaining in a cache entries identifying frequently used ‘conversations’ occurring in packets handled by the unit together with the relevant forwarding data, or at least a means of accessing the relevant forwarding data for such packets. The cache memory may be constituted by a content addressable memory which can rapidly provide access to the relevant forwarding data.

In a preferred form of the invention a look-up process comprises accessing the cache to determine whether a conversation, defined by an address pair, is the subject of an entry in the cache and resorting to a larger database if the conversation is not the subject of an entry in the cache.

The cache is preferably established and maintained by recourse to the table or list of conversations, preferably established by RMON techniques. In particular, as part of the lookup process, if a measure of traffic flow (such as a packet count) relevant to a first conversation represented by a packet is greater than that for a second conversation which is the subject of an entry in the cache, the first conversation (if not in the cache) may be put in the cache in place of the second The cache may be continually updated in this manner.

Further features of the invention will be apparent from a description of a more detailed example, with reference to the drawings.

### BRIEF DESCRIPTION OF THE DRAWINGS

FIG. 1 is a schematic diagram of a network unit which would typically host the present invention

FIG. 2 illustrates a trie search

FIG. 3 illustrates a conversation table

FIG. 4 illustrates a search process according to the invention.

FIG. 5 illustrates the interrelationship between the main functional parts participating in a search process according to the invention.

FIG. 6 is a flow diagram illustrating in simplified form a search process according to the invention

FIG. 7 is a flow diagram illustrating the search process more particularly in relation to the access to and control of the cache memory.

### DESCRIPTION OF A PREFERRED EXAMPLE

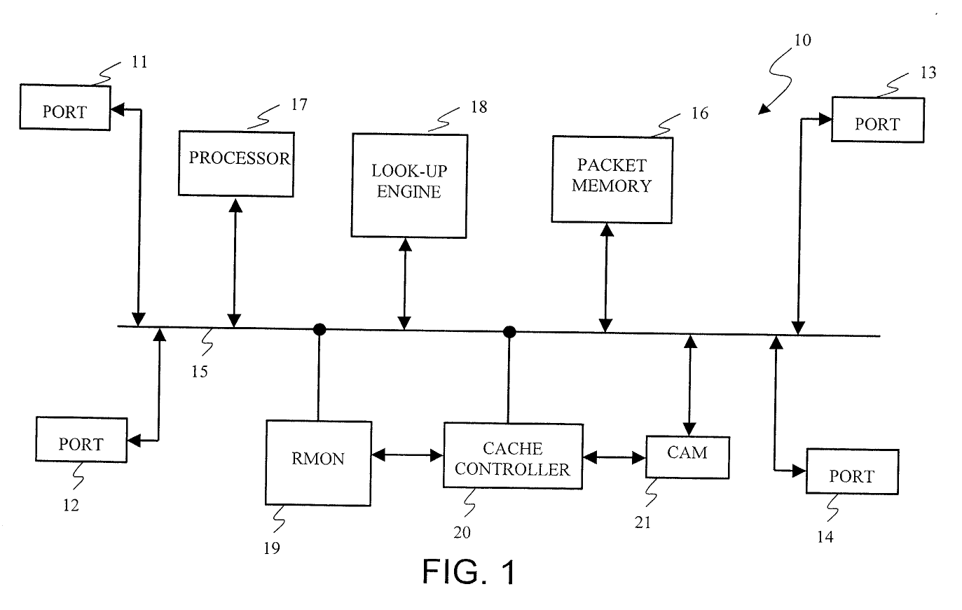

FIG. 1 of the drawings illustrates in a schematic manner a network unit 10 in accordance with the invention. The unit is intended to represent one example of a wide variety of units which can host the present invention.

Merely by way of example, the unit shown in FIG. 1 has a multiplicity of ports, represented in the example by four ports 11, 12, 13 and 14. These ports are adapted for connection to an external network by any suitable medium, for example twisted pair, coaxial line, fibre optic line or wireless link according to circumstances The ports 11 to 14 contain as is usual physical layer control and media access control, for example in accordance with the relevant transmission standard.

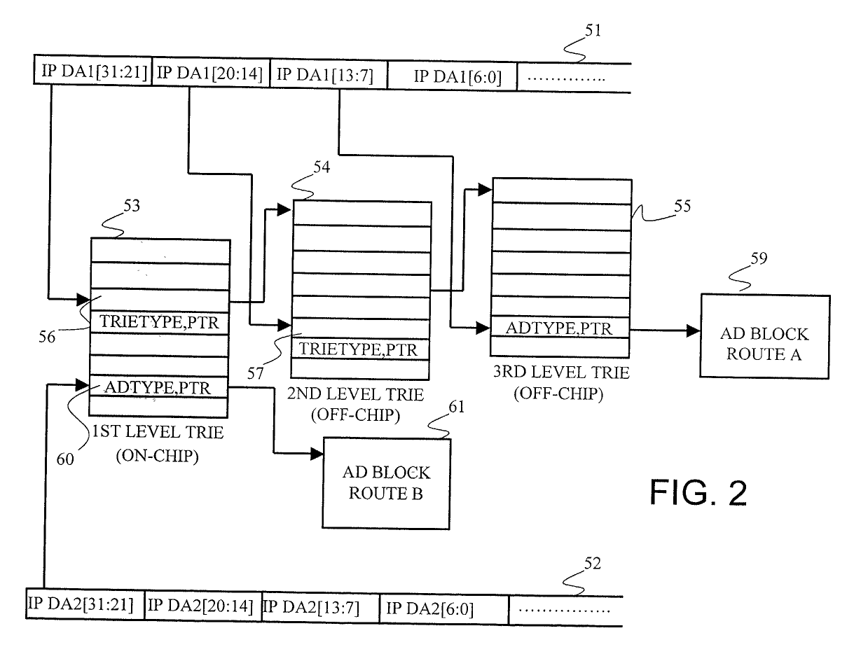

The unit includes a bus system which is shown as the bus 15 for the conveyance of control data, packet data and such like around the various parts of the unit Although the ports 11 to 14 may have temporary buffers associated with them, in accordance with known practice, storage of packets that have been received and before they are transmitted is effected in a central packet memory 16 In order to determine where a given packet should go, a look-up engine 18 is provided In essence this includes a database (e g as shown in FIG. 2) which contains entries relating address data to forwarding data (a number or other data identifying a port) so that for any given destination (which may be single or multiple) the accessing of the look-up table from the relevant data will yield the forwarding data which is used by a forwarding engine, in this example represented by the CPU 17, which will cause extraction of the relevant packet from memory 16 and the forwarding of the packet to the relevant port or ports.

As thus so far described the unit is commonplace and various different architectures are known and available commercially The remaining blocks in FIG. 1 will be described later.

As is more particularly described later, for a variety of purposes, such as load balancing in a server farm, it is desirable or necessary to perform look-ups using both source and destination data of a packet, and for this purpose a trie search facility may be provided.

FIG. 2 illustrates a known manner of organising a search table according to a trie look-up scheme The look-up table is organised in blocks to two types. One type, exemplified by blocks 53, 54 and 55, contain pointers which are either of a trie type, such as pointer 56, that point to another block of trie type or, as exemplified by pointer 60, are of an ‘associated data’ type which point to the second type of block, the AD block exemplified by blocks 59 and 61. The AD or associated data blocks contain the forwarding information for the relevant address key.

The first block, 53, in the trie search is accessed by the first set of bits from the trie key These bits identifyi a pointer within the block 53. In the case of a pointer such as pointer 56, which points to block 54, the pointer within block 54 will be accessed by the second set of bits from the trie key and so on until an associated data block, such as block 59, is reached.

It may be in some cases that a group of addresses share the same route, then the first part of the trie key will immediately yield, as in the case of pointer 60, a pointer to an associated data block 61 and it is then unnecessary to traverse the whole key in order to obtain the forwarding information.

FIG. 2 shows two keys 51 and 52 which are long keys composed of the internet protocol destination address and the internet protocol source address. They may also contain VLAN information.

For further information on the organisation of trie searches, reference may be made to European patent application EP-0551243-A2, U.S. Pat. No. 6,041,053 (Douceur et al) and international patent application publication number W096/00945.

As indicated in the foregoing, currently an entire address pair, the internet protocol destination address and internet protocol source address needs to be stored in a trie look-up table preferably with the number of the source VLAN. This means a search of the entire key may be needed. Typically, the key is read in slices of bits, for example an initial segment of eleven bits, subsequent segments of seven bits and a final segment of four bits, requiring up to ten reads from the trie search table.

A further known feature in switches of this kind is a remote monitoring facility, shown in FIG. 1 as “RMON” engine 19 In this example the remote monitoring system is coupled to the internal bus 15, as described in British patent GB-23 16589 and elsewhere.

Remote monitoring is known to provide a “conversation table” which is essentially a table indexed according to address pairs together with an indication of the number of times that address pair has occurred.

There is a variety of ways in which the remote monitoring can be performed. It may be done randomly, or at regular intervals. The measure of traffic flow for any given address pair maybe in terms of bytes or packets.

The RMON engine 19 monitors traffic that is bridged and/or routed by the unit For each packet (or each of a succession of sample packets at regular or pseudorandom intervals) entering the switch it checks whether an entry for a conversation pair has been entered in a table in static random access memory If it has not been so entered, the RMON engine creates a new entry If an entry does exist it updates the statistics for the conversation.

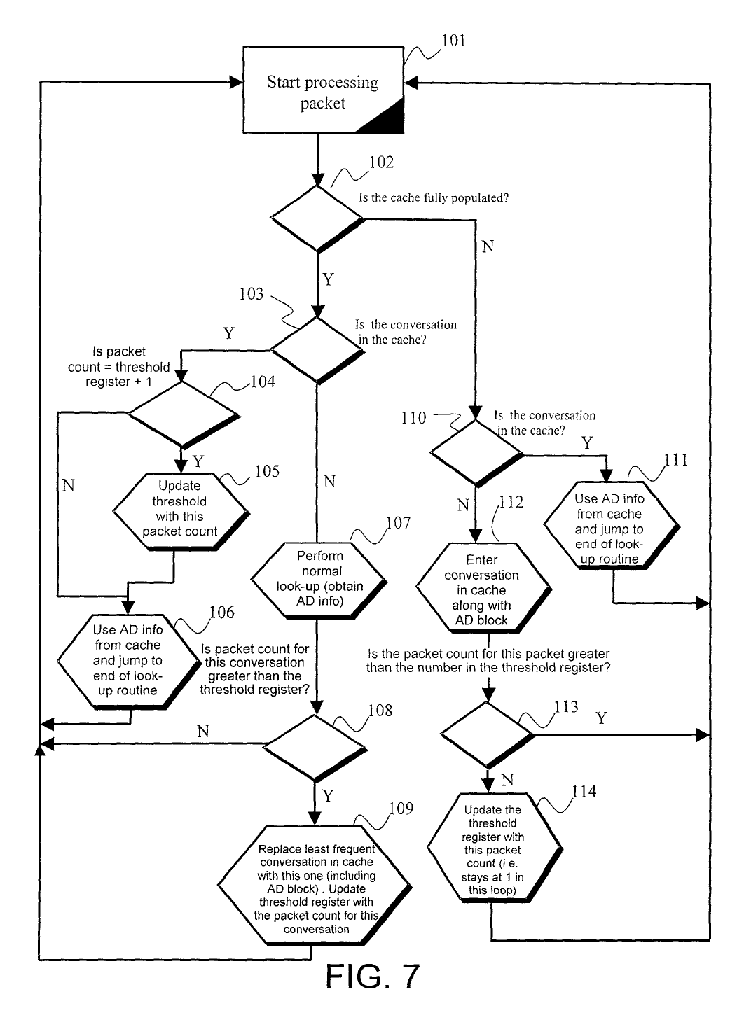

The address pairs for the most active conversations as determined by the RMON engine are put into a cache memory, namely the CAM (content addressable memory) 21 Along with each entry will be a pointer to the associated data block for this conversation The access to the CAM 21 and its updating is controlled by a cache controller 20, preferably constituted by a state machine which will be described with reference to FIG. 7 For each packet entering the switch the relevant destination and source address data will be entered into the cache if this conversation has more frequently occurred then the least frequent in the cache and if it has not been entered before. Entries may also be aged out if they are inactive for a specified time Each time the associated data block is added or removed or a branch of layer 3 trie search is modified, the AD block pointer in the cache will be updated accordingly.

When a layer 3 packet is about to be looked up, its destination address and source address will be compared with the entries in the cache. If the entry is found the pointer will be used to go straight to the AD block This saves many reads and enables routing of these packets at the wire rate.

A variation on this method is to have the associated data block located in the cache also. In this case each time the information and the associated data block is modified the corresponding entry in the cache needs to be updated.

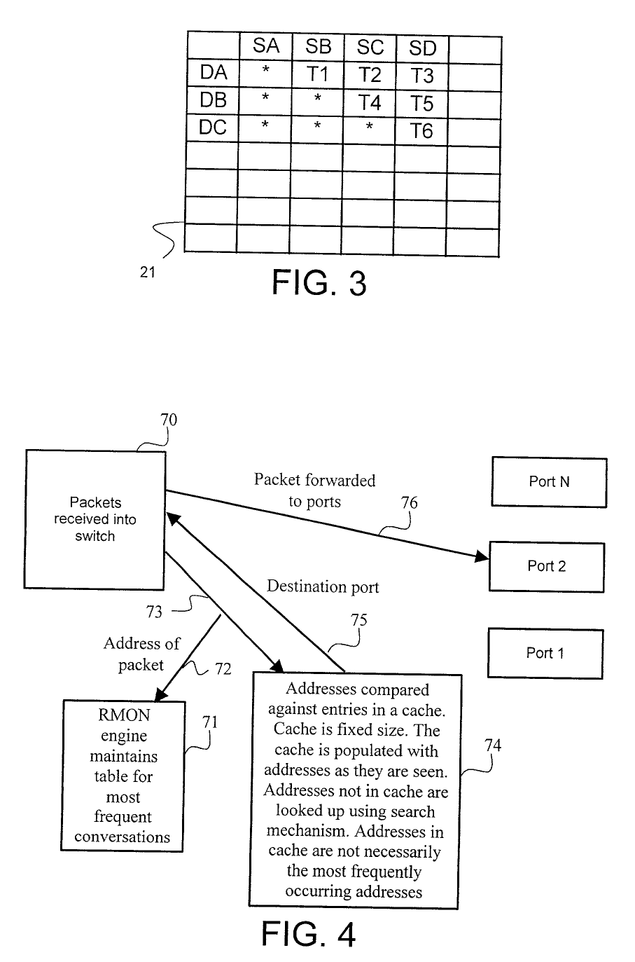

FIG. 3 illustrates a known form of conversation table 21 which can be constructed using a known RMON engine 19 The monitoring system is, for example, coupled to the main data bus of the switch so that it can snoop on packets (or a regular or random selection of packets) in order to obtain, at each sample, the IP destination and source addresses of the sampled packet The conversation table also needs a measure of the traffic; this may be represented by a count of packets or may be represented by a byte count according to preference The conversation table thus has entries schematically represented in FIG. 3, each of which identifies an IP source and destination pair and contains an indication of the packet count flowing between that pair The source addresses are SA, SB etc and the destination addresses are DA, DB etc. The values T1, T2 etc represent the volume of traffic containing the respective pair of addresses.

FIG. 4 illustrates in a generally schematic form a search process according to the invention.

Block 70 represents the known process by which packets are received into the switch, temporarily stored in packet memory and so on. Block 71 represents the operation of the RMON engine, which maintains a table for the most frequent conversations, as obtained by examination of the packet headers as more fully described later. Line 72 represents the updating of the RMON engine as each new packet is received by the switch. Arrow 73 represents a look-up request performed in respect of a packet while it is stored in the switch in order to obtain the forwarding data for the particular packet.

Block 74 represents the search process performed according to the invention. The pair of addresses (IPSA and IPDA) are compared with the entries in the cache, which is normally a fixed size The cache is populated with addresses as they are seen (FIG. 7). If the address pair is not in the cache, the ‘ordinary’ look-up process will be initiated, as denoted by arrow 75. That process will normally yield the forwarding data, so that the packet is forwarded (arrow 76) to one or other of the ports.

Owing to the nature of the RMON engine, the entries in the cache are not necessarily the most frequently occurring conversations at any given time, though statistically they will constitute most of the frequent conversations

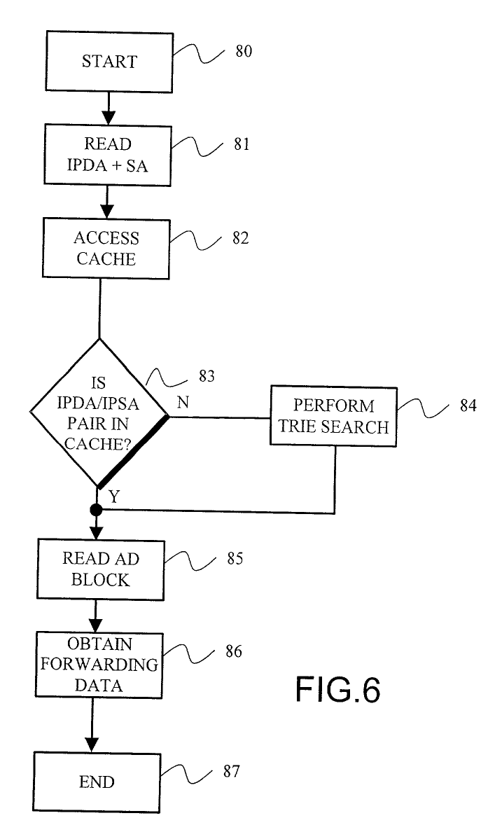

The search process if summarised in FIG. 6. From a start 80 the addresses obtained from a packet, stage 81, are read. The cache is accessed, stage 22. The cache will be populated with addresses as they are seen If the address pair, the IP destination address and IP source address are in the cache (stage 83), then the associated data block (stored in the cache along with the address pair) is read (stage 85), the forwarding data obtained (stage 86) and the process terminated If the address pair is not available from the cache, a look-up will be performed by means of the trie search facility (stage 84) as previously described with reference to FIG. 2.

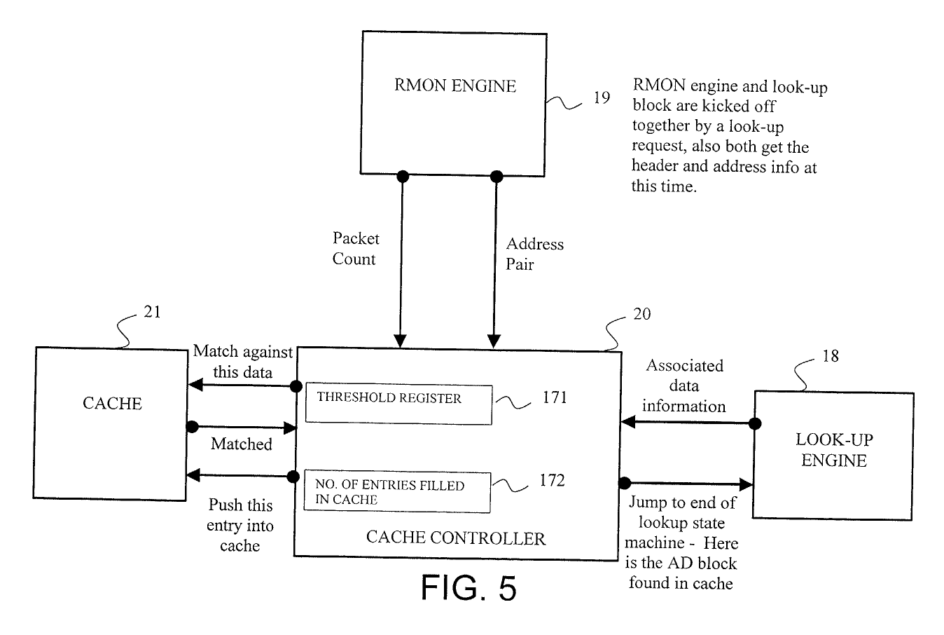

FIG. 5 shows the interrelationship between the principal functional parts of the search process, involving the cache 21, the RMON engine 19, the cache controller 20 and the lookup engine The RMON engine provides packet counts and address pairs. The cache controller 20 maintains a threshold and the number of entries filled in the cache, in registers 171 and 172 The cache controller has recourse to the cache to determine whether the address pair is matched against data held in the cache and the cache will signal the cache controller to signify a match. The cache controller will also push an entry on to the cache under certain conditions to be described later.

FIG. 7 illustrates more specifically the operation of the cache controller. The start of the process shown by FIG. 7 is the commencement 101 of the processing of the packet At stage 102 the controller determines whether the cache is fully populated. Initially it will be assumed that the cache is fully populated so that the next stage 103 is a determination whether the conversation (the particular IP source and destination address pair) is in the cache. If the conversation is the cache, there is a determination 104 whether the packet count is equal to a value held in threshold register 171 incremented by unity If it is, then the threshold register is updated (105) with the new packet count.

Then the AD information from the cache entry (or elsewhere) is obtained (106) and a jump is made to the end of the look-up routine.

If the conversation is not in the cache several actions will be required One (107) is to perform the ordinary look-up (e g as shown in FIG. 2). At stage 108 the controller determines whether the packet count for the conversation is greater than that in the threshold in register 171 If the packet count for the conversation is not greater than the threshold register there will be no need to enter this conversation in the cache and the process will terminate in readiness for the processing of the next packet If however the packet count for the conversation is greater than the count in the threshold register then the least frequent conversation in the cache will be replaced (stage 109) by the conversation represented by the new packet, including the AD block when it is found The threshold register will be updated with the packet count for this conversation.

If however the cache is not fully populated then the new conversation may be entered into the cache. A determination (110) will be made whether the conversation is in the cache already If it is, then the AD information from the cache is employed (stage 111) and there is a jump to the end of the look-up routine If the conversation is not in the cache, and the cache is not fully populated, the conversation must be entered in the cache (stage 112) This will be accompanied by the AD block There needs also to be a determination (stage 113) whether the packet count for the packet is greater than the number in the threshold register If it is not, then the threshold register will be updated (stage 114) with the packet count.

1 A network unit which includes
a look-up engine for performing an address look-up in response to a key including a network address pair in a packet to obtain forwarding data for said packet,
means for monitoring conversations defined by network address pairs in packets received by the unit to obtain measures of traffic flow for said conversations;
a cache memory for storing entries accessible by network address pairs and enabling forwarding data to be obtained for entries in the cache, and
a cache controller operative
(i) to cause in response to a look-up request a determination whether the address pair in a packet is held in the cache,
(ii) to allow the look-up engine to perform the address look-up when the address pair in said packet is not held in the cache, and
(iii) to update said cache so as to displace entries associated with relatively low measures of traffic flow by entries associated with relatively high measures of traffic flow.

2 A network unit according to claim 1 wherein the cache controller is operative, when the address pair of the packet is not held in the cache, to compare the measure of traffic flow with a threshold and to insert the address pair as a new entry in the cache if the measure exceeds the threshold and is operative when the address pair of the packet is held in the cache to determine whether the said measure exceeds said threshold and thereupon to increase said threshold

3 A network unit according to claim 2 wherein the cache controller is operative to remove the entry associated with the least measure of traffic flow when inserting said new entry.

4 A network unit according to claim 1 wherein said look-up engine is organised to perform a trie search

5 A network unit which includes
a look-up engine for performing an address look-up in response to a key including a network address pair in a packet to obtain forwarding data for said packet,
means for monitoring conversations defined by network address pairs in packets received by the unit to obtain measures of traffic flow for said conversations,
a cache memory for storing entries accessible by network address pairs and enabling forwarding data to be obtained for entries in the cache, and
a cache controller operative:
(i) to cause in response to a look-up request a determination whether the address pair in a packet is held in the cache,
(ii) to allow the look-up engine to perform the address look-up when the address pair in said packet is not held in the cache,
(iii) when the address pair of the packet is not held in the cache, to compare the measure of traffic flow with a threshold and to insert the address pair as a new entry in the cache if the measure exceeds the threshold, and
(iv) when the address pair of the packet is held in the cache, to determine whether the said measure exceeds said threshold and thereupon to increase said threshold

6 A network unit according to claim 5 wherein the cache controller is operative to remove the entry associated with the least measure of traffic flow when inserting said new entry

7 A network unit according to claim 5 wherein said look-up engine is organised to perform a trie search
